(19) United States
(12) Patent Application Publication
(10) Pub. No.: US 2001/0005360 A1
(43) Pub. Date: Jun. 28, 2001

(54) Method and apparatus for monitoring network state

(76) Inventors: Kyoung-Woo Lee, Seoul (KR); Sang-Hyup Lee, Seoul (KR)

Correspondence Address: BIRCH, STEWART, KOLASCH & BIRCH, LLP, P.O. Box 747, Falls Church, VA, 22040-0747, US

(21) Appl. No.: 09/742,382

(22) Filed: Dec. 22, 2000

(30) Foreign Application Priority Data
Dec. 23, 1999 (KR) 61231/1999

(51) Int. Cl. H04L 1/00

(52) U.S. Cl. 370/236

(57) ABSTRACT

A method for monitoring a network state includes the steps of assigning a destination and a monitor period to a module for monitoring a state of a network installed in a source area; generating a specific packet for measuring a bandwidth and a degree of congestion of the network; transmitting the specific packet through a network layer to a designated destination; returning the packet received by the destination to the source area; analyzing a message transmitted from the destination and measuring a bandwidth and a degree of congestion of the network; and repeatedly performing the step of generating the packet and the following steps in every assigned monitor period during a predetermined time, thereby recognizing a network state.

### BACKGROUND OF THE INVENTION

1. Field of the Invention

The present invention relates to a method and apparatus for monitoring a network state utilized in a network application program connected with the Internet, and more particularly, to a method and apparatus for monitoring a network state which is capable of judging and predicting a network state on the basis of a bandwidth of a network, a packet loss amount and an error occurrence rate, so as to provide an optimum service required by a client.

2. Description of the Background Art

Generally, as a method for monitoring a network state, there are two methods: one method is to use a separate hardware equipment which connects networks, and another method is to judge and predict a network state by installing a network measurement module in an application program of a network PC (Personal Computer).

Additional hardware equipment for measuring a network state includes a Lan card, a Bridge, a Hob and a Router, with which a data provided by a network operating system is analyzed to monitor an Internet network state.

The Router will now be described as an equipment to recognize a network state by using the hardware.

When a client requests information from a server, the router recognizes the number of hops (that is, the number of nodes passed by data to reach a destination network) and the current state of activated paths, based on which a path for transmitting a data is selected. In case that the selected path is busy, other path is selected to transmits the data. At this time, the router is operated including the lower three layers of a physical layer, a link layer and a network layer among the OSI 7 layers, so that the lower three layers can be used to connect different networks.

However, in order to monitor the network state, upper layers higher than a transport layer should operate the same protocol, so that it is difficult to accurately recognize the network state. In addition, a hardware equipment for monitoring the network state is additionally required, so that high expense is incurred.

In the method for installing a network measurement module in an application program of a network PC monitors, a specific module for measuring a degree of congestion of a network in application programs of server and of a client, thereby monitoring a network state.

However, the conventional network monitoring method has a problem in that since the same module should be installed in the application programs of the server and of the client to recognize the degree of congestion of a network, and since the monitoring method is very complicated, only persons having expertise on the network can use the method.

### SUMMARY OF THE INVENTION

Therefore, an object of the present invention is to provide a method and apparatus for monitoring a network state in which a module for monitoring a network state is used to measure a degree of congestion of the network in a network layer, thereby recognizing more practical network state.

To achieve these and other advantages and in accordance with the purpose of the present invention, as embodied and broadly described herein, there is provided a method for monitoring a network state including the steps of: assigning a destination and a monitor period to a module for monitoring a state of a network installed in a source area; generating a specific packet for measuring a bandwidth and a degree of congestion of the network; transmitting the specific packet through a network layer to a designated destination; returning the packet received by the destination to the source area; analyzing a message transmitted from the destination and measuring a bandwidth and a degree of congestion of the network; and repeatedly performing the above steps after the step of generating the packet in every assigned monitor period during a predetermined time to thereby recognize a network state.

To achieve the above objects, there is also provided an apparatus for monitoring a network state which includes a source area system having a module for transmitting a specific packet through a destination connected to a network and the network to the destination system, analyzing a packet transmitted from the destination, and measuring a bandwidth and a degree of congestion of the network, to thereby recognize a network state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a network state monitoring system in accordance with the present invention;

FIG. 2 is a flow chart of a network state monitoring method in accordance with the present invention;

FIG. 3 illustrates a construction of a packet in accordance with the present invention;

FIG. 4 illustrates a construction showing an ICMP in an OSI 7 layers of ISO in accordance with the present invention; and

FIG. 5 illustrates an Internet service system providing a multimedia application environment in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

A network state monitoring method and apparatus of the present invention will now be described with reference to the accompanying drawings.

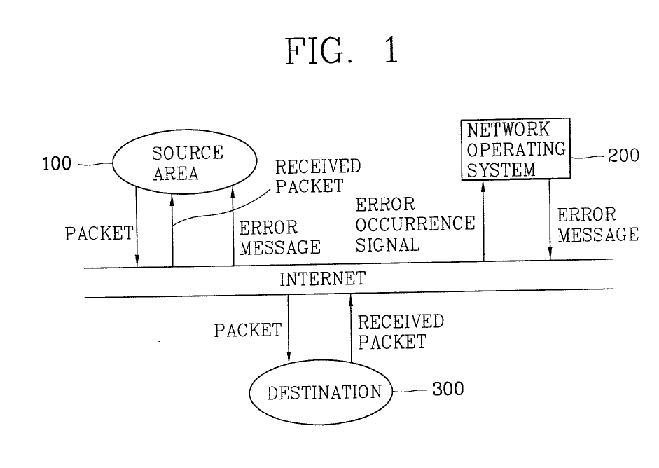

FIG. 1 illustrates a network state monitoring system in accordance with the present invention.

As shown in the drawing, the network state monitoring system includes a source area 100 in which a network state monitoring module is installed, a destination 300 corresponding to an arbitrary system connected with the source area through the Internet, and a network operating system 200 for sensing an error on the network.

First, when the source area 100 transmits a specific packet through a network layer to a designated destination 300, the destination 300 returns the received packet to the source area. At this time, in case that an error occurs during the transmission of the packet, the network operating system 200 transmits an error message to the source area 100. Then the source area 100 analyzes the message transmitted from the destination or from the operating system and measures the bandwith and the degree of congestion of the network to recognize a network state, so that a data suitable to the bandwith of the network can be transmitted.

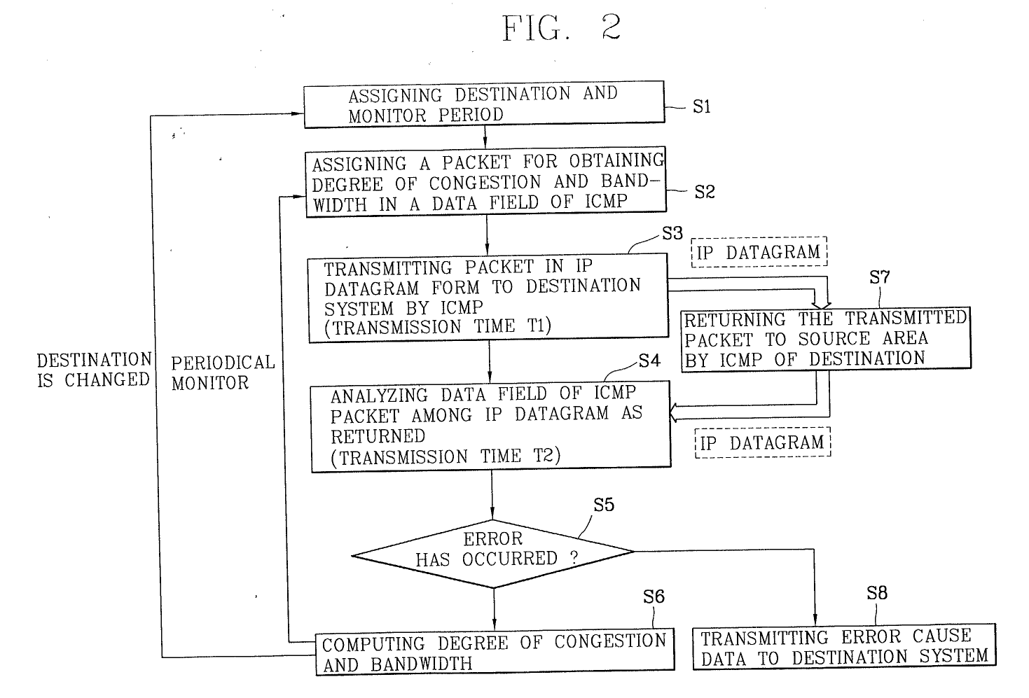

The operation and effect of the present invention will now be described with reference to FIGS. 2, 3 and 4.

FIG. 2 is a flow chart of a network state monitoring method in accordance with the present invention.

First, a destination and a monitor period are assigned in the network state monitoring module installed in the source area (S1).

A packet is assigned in a data field of an ICMP (Internet Control Mangement Protocol) to obtain a bandwith and a degree of congestion of the network between the source area and the destination (end-to-end) (S2), thereby generating an S-bit IP (Internet) datagram, that is, a packet.

The source area system transmits the generated IP datagram to the destination system through the ICMP (S3), of which the transmission time is set by ‘T1’.

The packet transmitted through the ICMP is returned from the destination system to the source area system (S7).

At this time, in case that an error occurs on the network, the network operating system detects the occurrence of the error and transmits an error message to the source area.

The source area system receives the packet from the destination system or from the network operating system and analyzes the received message (S4), of which the message receiving time is set by ‘T2’.

The source area system analyzes the received message, and in case that there is an error, the source area system receives an error cause data from the destination system (S8). Meanwhile, in case that there is no error, the source area system computes a degree of congestion and a bandwidth of the network. The bandwidth of the network is computed by dividing the length of the packet by a IS difference between the receiving time and the transmission time, and the degree of congestion of the network is measured in a manner that the loss and the order of the packet from the permutation number in the packet of the IP datagram, and the degree of congestion is measured on the basis of the computed bandwidth, the packet loss amount or whether an error has occurred.

Formula representing the bandwidth of the network is as follows.

A network bandwidth (bps)=S/(T2−T1) (1)

wherein S indicates the length of the packet, T1 indicates a time at which the source area transmits the IP datagram to the destination, and T2 indicates a time at which the packet transmitted from the destination is received.

In case that the source area and the destination are the same, in order to obtain a bandwidth and a degree of congestion of a network between the source area and the destination (end-to-end), it returns to the step S2 in which a packet is assigned in the data field of the ICMP (Internet Control Management Protocol), and the steps S3, S4, S5, S6, S7 and S8 are performed for a predetermined time in every assigned monitor period, to obtain an average value and the maximum and the minimum values, thereby recognizing the degree of congestion of the network as well as the network state.

Meanwhile, in case that the source area changes the destination, the steps after the step of assigning the destination and the monitor period are again performed.

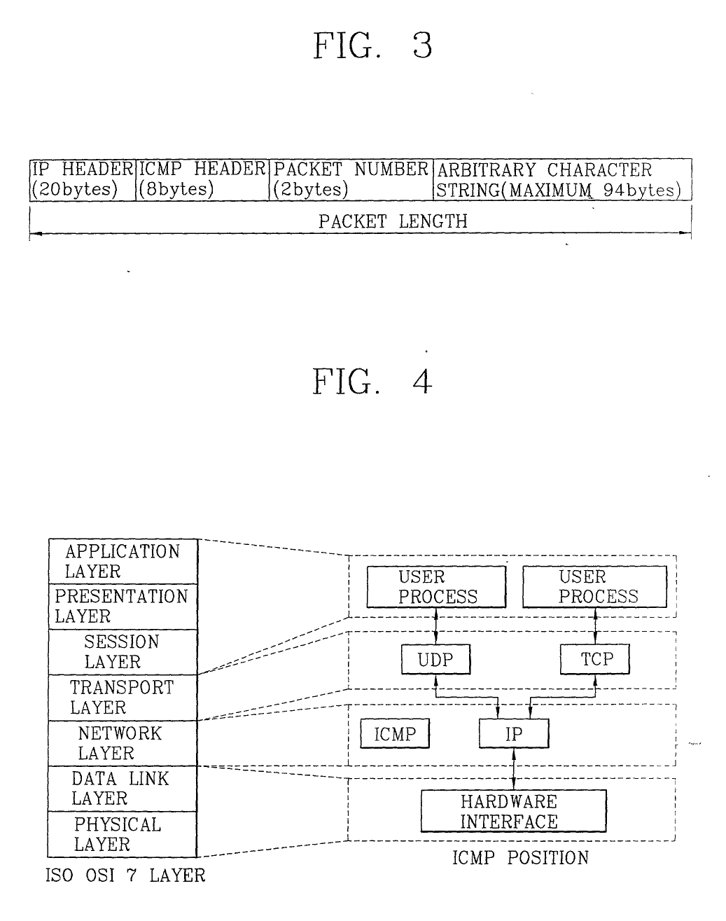

FIG. 3 illustrates a construction of a packet in accordance with the present invention.

As shown in the drawing, the IP datagram transmitted through the ICMP includes an IP header, an ICMP header, a packet number and an arbitrary character string. Assuming that the length of the packet is ‘S’, 124 byte data at the maximum can be stored the packet so as to be transmitted.

FIG. 4 illustrates a construction showing an ICMP in an OSI 7 layers of ISO in accordance with the present invention.

With reference to FIG. 4, the ICMP positioned at the network layer of the OSI (Open System Interconnect Mode) 7 layers is utilized in which a bandwith value close to a bandwidth value obtained in the TCP and the UDP of the transport layer can be obtained, which is not affected by the TCP and the UDP of the transport layer positioned at the upper portion of the network layer. Also, the bandwidth value is not affected by layers positioned above the transport layer.

As described above, in the network monitoring method, since the bandwidth value obtained in the ICMP is affected only by the lower portions of the network layer, without being affected by the layers above the transport layer, the network state can be recognized close to the network situation, the network connection state of an arbitrary destination system can be recognized, and the degree of congestion of the TCP/IP layer of the Internet protocol, that is, the degree of congestion of network itself, can be measured.

In addition, even though the module for monitoring the network state is installed only at one side of either the source area or the destination, the network state can be monitored. In case where a module for monitoring a network state is installed at one side, there is a load only in a system where the monitoring module is positioned while there is no load in a system without having the module or there is little load negligible in a system without having the module. Thus, the load of the whole system and network can be minimized.

Moreover, in the method for monitoring the network state, once the TCP/IP is mounted at a system connected with the Internet, a network state can be monitored, so that the bandwidth and a degree of congestion of the network can be recognized.

The method for monitoring a network state of the present invention is applicable to every application program for measuring a degree of congestion of a general network, that is, a network of the Internet or an Intranet.

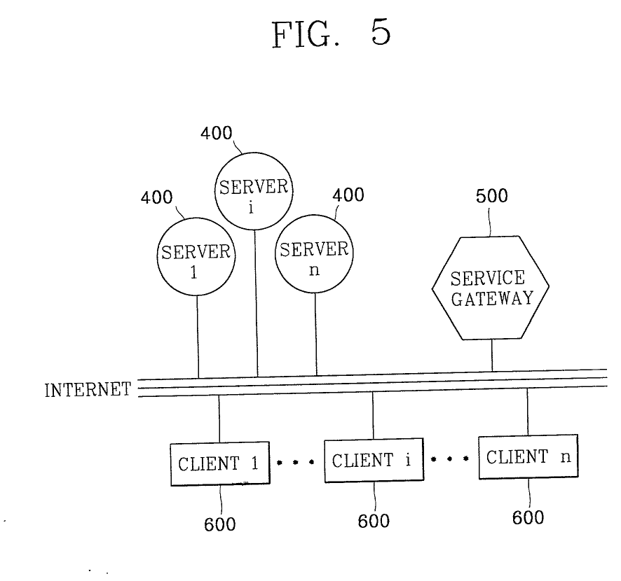

FIG. 5 illustrates an Internet service system providing a multimedia application environment in accordance with the present invention.

As shown in the drawing, the Internet service system includes a plurality of servers 400 for providing multimedia contents, a plurality of clients 600 for displaying data transmitted from the servers 400 for users, and a Web-based service gateway 500 for providing Internet information and additional information to the user.

In the Internet service system, an arbitrary client 600 selects a service content according to the method for monitoring a network state as described above among the servers 400 providing a requested service. In case of a system having several servers 400, the service gateway 500 can balance a load for the service requested by the client 600 by using the method for monitoring a network state.

Meanwhile, a server 400 including a plurality of contents of the same content having various kinds of encoding rates selects a specific contents executable in the current network situation for the service requested by the client 600 to provide a service.

As so far described, the method and apparatus for monitoring a network state of the present invention has the following effects.

That is, first, the degree of congestion and the bandwidth of a network is measured in the network layer, so that an actual network state can be recognized.

Secondly, even though a module for monitoring a network is installed only at one side of either a source area or a destination, a network state can be monitored, so that the load of the whole system and the network can be minimized.

Thirdly, it is not necessary to employ a hardware to monitor a network state as in the conventional art , so that the network state can be monitored at a low expense.

Lastly, since the ordinary users without expertise on the network can recognize the network state, its utilization can be heightened.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A method for monitoring a network state comprising the steps of:
assigning a destination and a monitor period to a module for monitoring a state of a network installed in a source area;
generating a specific packet for measuring a bandwidth and a degree of congestion of the network;
transmitting the specific packet through a network layer to a designated destination;
returning the packet received by the destination to the source area; analyzing a message transmitted from the destination and measuring a bandwidth and a degree of congestion of the network; and
repeatedly performing the step of generating the packet and the following steps in every assigned monitor period during a predetermined time, thereby recognizing a network state.

2. The method according to claim 1, wherein in case that an error occurs during the transmission of the specific packet through the network layer to a designated destination, comprising the steps of:
detecting an error signal in the network operating system;
transmitting an error message to the source area; and
analyzing the received error message to measure a bandwidth and a degree of congestion of the network, thereby recognizing a network state.

3. The method according to claim 1, wherein the bandwidth of the network is computed by dividing the size of the packet by the difference between the time at which the packet is transmitted from the source area and the time at which the message transmitted from the destination is received by the source area.

4. The method according to claim 1, wherein the degree of congestion of the network is computed by measuring a bandwidth and a packet loss amount or judging over whether an error has occurred.

5. The method according to claim 1, wherein in case that a destination is changed, the step for assigning a destination and a monitor period and the following steps are sequentially performed again.

6. An apparatus for monitoring a network state which includes a source area system having a module for transmitting a specific packet through a destination connected to a network and the network to the destination system, analyzing a packet transmitted from the destination, and measuring a bandwidth and a degree of congestion of the network, to thereby recognize a network state.

7. The apparatus according to claim 6, wherein the module for recognizing a network state is installed at one side of either the destination or the source area.
